(19) United States
(12) Patent Application Publication
(10) Pub. No.: US 2006/0164771 A1
(43) Pub. Date: Jul. 27, 2006

(54) Device for transmitting, exchanging and/or routing data and/or information

(76) Inventor: Sebastian Heidepriem, Neuenburg (DE)

Correspondence Address: BACON & THOMAS, PLLC, 625 SLATERS LANE, FOURTH FLOOR, ALEXANDRIA, VA, 22314, US

(21) Appl. No.: 10/524,786

(22) PCT Filed: Aug. 16, 2002
(86) PCT No.: PCT/EP02/09191

§ 371 Date: Sep. 12, 2005

(51) Int. Cl. H02H 3/20

(52) U.S. Cl. 361/91.2

(57) ABSTRACT

A device for transmitting, exchanging and/or routing data and/or information, in the context of industrial process and/or automation technology, between a first unit and at least a second unit. One of those units is a transmitter or sensor supplying a measurement value for determining a physical or chemical quantity. Said units form part of a combined assembly or network of several units which communicate with one another directly or indirectly by means of at least one intermediate unit, each of the units comprising at least two physical communication interfaces and at least one microprocessor.

The invention relates to a device for transmitting, exchanging, and/or forwarding data and/or information in the context of industrial process- and/or automation technology.

From the state of the art, it is known to have sensors or transmitters communicating via a bus system digitally with one another, and/or with a remote control station. Prerequisite for smooth communication is, on one hand, continuous availability, and, on the other hand, an adequately large capacity, of the data line which is used in the bus system. The data line is normally a two- or multi-strand cable. If the data line fails for any reason, or if its capacity is exhausted, then this leads to the fact that an efficient and timely data transfer, for example, the transfer of a measured value, can no longer take place. If one considers the case that, depending on the measured value to be transmitted, a safety valve is to be opened or closed, then it goes without saying that conventional bus systems cannot, without further measures, adequately accommodate the high safety demands in the fields of process- and automation technology.

An object of the invention is to provide a device which permits a redundant communication without overloading the data line.

The object is achieved by having a first unit and at least a second unit communicate with each other, with one unit being a transmitter or sensor, which supplies a measured value for determining a physical or chemical parameter. The at least two units belong to a combined assembly, or network, of a plurality of units, which, either directly, or indirectly via at least one intermediate unit, communicate with one another, with each of the units having at least two physical communication interfaces, and with at least one microprocessor being assigned to each unit.

In principle, the device of the invention uses a multiple networking of the sensors and/or transmitters—analogous to an interconnected group of computers, which forward data and/or information via the Internet. Through this, it is possible to optimally load the data lines to their full capacities. Even in the case of the transfer of large amounts of data, relatively small transfer times can be achieved, since, for example, the data can be sent in parallel along different paths to the addressee.

Furthermore, a redundant data communication is possible, because normally a sensor or transmitter can exchange data and information with another sensor or transmitter via a plurality of different paths. Consequently, it is possible that the individual units communicate with one another, without the entire bus system always becoming too heavily loaded.

In particular, this enables the use of small band widths for the transfer of data and/or information, which, in turn, is reflected in an increased resistance to interference. Incidentally, this is especially advantageous when the units, sensors, or transmitters, are used in areas where there is danger of explosion. Here, the use of small band widths for the transfer of data is widespread.

In accordance with a further development of the device of the invention, the transmitter or sensor can be a fill level measuring device, a pressure transmitter, a flow rate sensor, a temperature sensor, or an analytical device. The assignee, or enterprises associated with the assignee, as the case may be, distribute a wide variety of sensors and transmitters for determining and/or monitoring physical and/or chemical variables. In principle, a units used in the device of the invention naturally need not be a transmitter or sensor. The term “unit” can describe any unit having at least two physical communication interfaces and a microprocessor. Thus, naturally, a unit can also be a communications unit, a router, an evaluation/control unit, a parametering unit, or an actuator.

It is considered an especially favorable embodiment of the device of the invention that, in the microprocessor of a first unit, which transmits data and/or information to at least a second unit, information concerning the topology of the network is contained, and that preferably this information concerning the topology is transmitted with the data and/or information. In effect, the data and/or information to be transmitted is accompanied by information concerning the path by which it can get to the respectively addressed unit—in the following, the respective addressee—the fastest.

In order to ensure that the data and/or other information reaches the desired addressee, it is alternatively provided that, in the microprocessors, in at least one part of the units, the information concerning the topology of the network is saved, so that, on the basis of the addressee to which the data and/or information is to be sent, the corresponding unit recognizes the path, or alternative path, along which the data and/or information must be sent, or forwarded, as the case may be.

In accordance with a further embodiment of the device of invention, it is provided that a unit determines the topology of the network via communication with the neighboring unit or units, stores the acquired information in a memory unit, and thus recognizes along which path, or alternative paths, it preferably sends, or forwards, as the case may be, the data and/or information.

For the purpose of selecting optimal communication paths, it is provided that a unit determines, once, sporadically, or cyclically, the capacity of a communication path to the different units communicating with it directly or indirectly, and stores the individual communication paths with differentiated classification in an assigned memory unit.

A further alternative embodiment for reaching the respective addressee is the trial/error variant: a unit forwards the data and/or information to at least any one unit; the respective unit receiving the data and/or information forwards the data and/or information in the same manner until the data and information reaches the unit to which the data and/or information are addressed. In the case of this variant, in order to avoid that the data lines become overburdened, a unit only forwards the data and/or information as long as a predetermined number of forwardings is not yet attained.

In order to ensure that important information is transmitted chronologically before less important information, the units transfer the data and/or information on the basis of predetermined priority criteria.

In accordance with a preferred embodiment of the device of the invention, in the case of a large amount of data and/or information to be transferred, a unit selects multiple, mutually independent communication paths in order to transfer the data and/or information in parallel. This embodiment allows even large amounts of data to be quickly transmitted to the respective addressee.

An advantageous development of the device of the invention provides converters, which are assigned to the units, such that the units can communicate with one another via different types of transmission. These converters can also be sensors which support different types of transmission at the various interfaces.

In accordance with an advantageous development of the device of the invention, either connecting cables or fiber optic cables, or ways of so-called wireless data- and/or information transfer are used as ways of communication.

The invention will now be described in greater detail on the basis of the drawings, the figures of which show as follows:

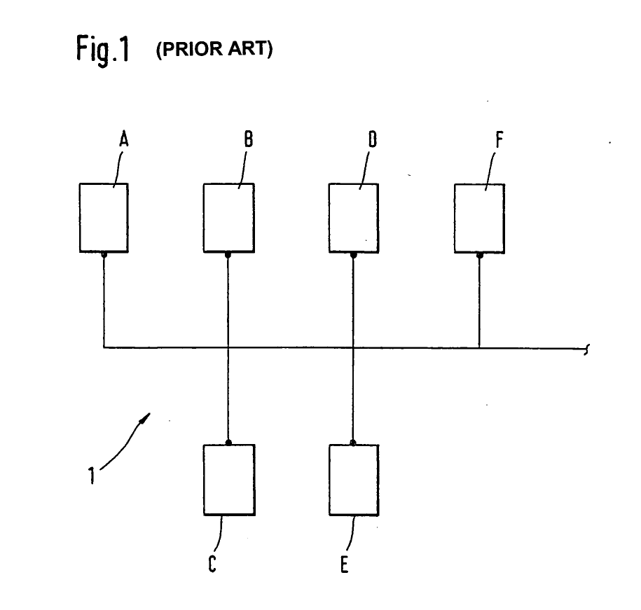

FIG. 1 a schematic illustration of a known bus system;

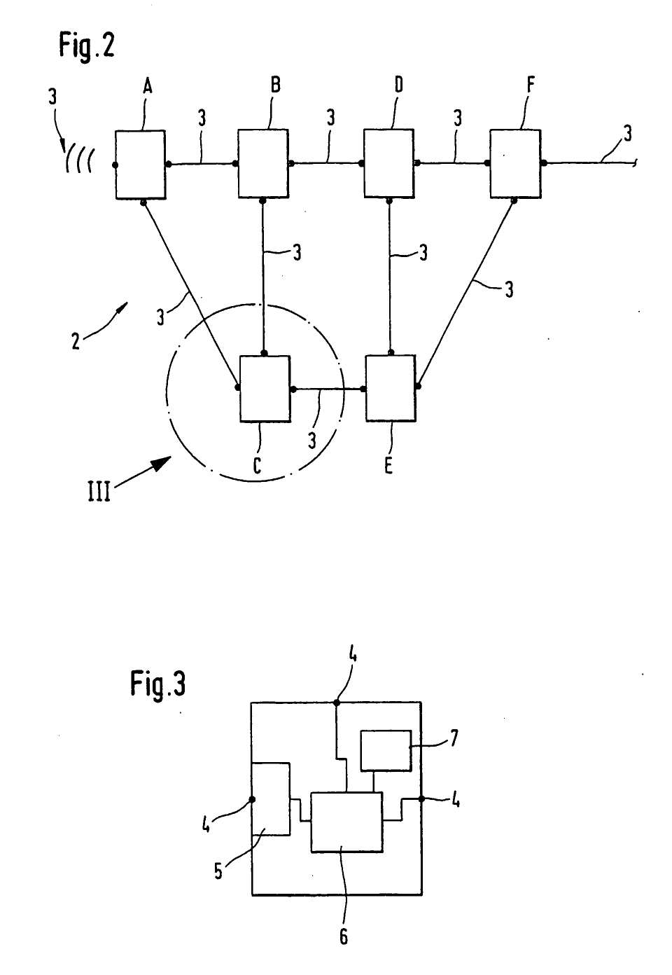

FIG. 2 a block diagram of a first variant of the network of the invention;

FIG. 3 an enlarged schematic illustration of a section of the network shown in FIG. 2;

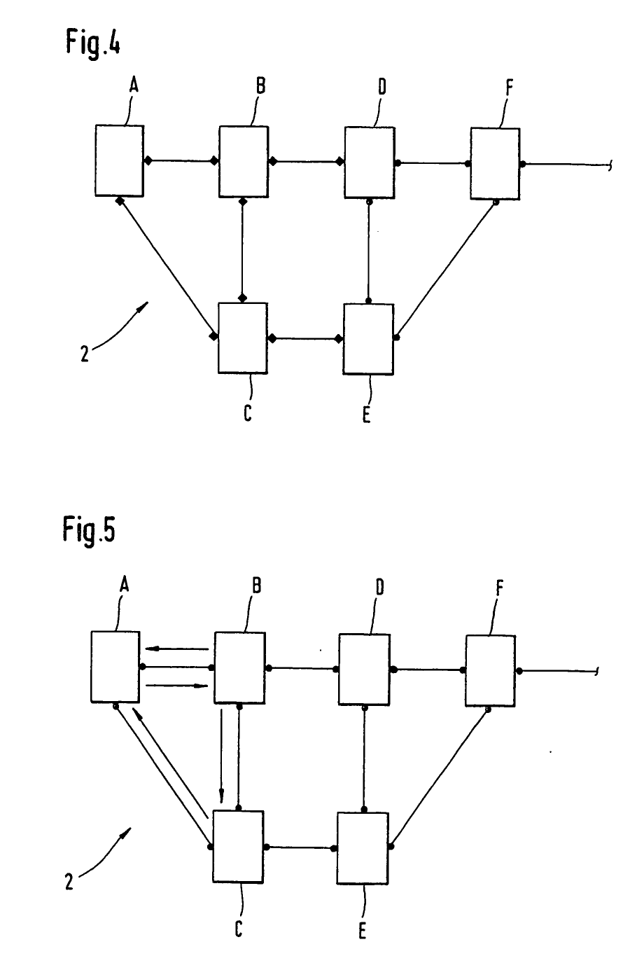

FIG. 4 a block diagram of a second variant of the network of the invention; and

FIG. 5 a block diagram of a third variant of the network of the invention.

FIG. 1 shows a schematic illustration of a known bus system 1, by way of which multiple units A, B, C, D, E, F communicate with one another, or with a remote control station (not shown). The units A, B, C, D, E, F can be sensors, transmitters, evaluation units, parametering units, or other devices. A disadvantage of known, digital communication-bus systems 1 is that every communication between any two units, e.g. A and D, always inherently burdens the entire bus system. This arises from the fact that not only the desired addressee, but, inevitably, every other unit B, C, E, F connected to the bus 1 also receives the data and/or information which is transmitted between the units A and D—and, indeed, regardless of whether the data and/or information is required at these other locations, or not.

In FIG. 2, a block diagram of a first variant of the network 2 of the invention, composed of multiple units A, B, C, D, E, F, is shown. Each of the units A, B, C, D, E, F has at least two physical interfaces 4 (see the detail in FIG. 3). By way of the physical interfaces 4, each unit A, B, C, D, E, F is, in each case, connected with at least one additional unit. In the network 2, all units A, B, C, D, E, F are connected directly or indirectly with one another. Thus, there is no longer—as in the state of the art—a bus system 1 (see FIG. 1), to which the units A, B, C, D, E, F are connected; rather, the network 2 of the invention exhibits a construction which is typical for the Internet: in addition to the direct and/or shortest connection between two units, longer and/or indirect connections via third units are also always available. The communication paths 3, by way of which the units A, B, C, D, E, F communicate with one another, can be e.g. data lines or fiber optic cables; of course, the communication can also be accomplished wirelessly.

In the case of the network 2 of the invention shown in FIG. 2, the following units can, on the basis of direct physical coupling, communicate directly with one another: A and B, A and C, B and C, B and D, C and E, E and D, E and F, D and F. Thus in the example shown, e.g. the unit A cannot communicate directly with the unit E. However, in accordance with a variant of the device of the invention, the unit A can send data to the unit C, and this unit C can further transmit the data to the unit E. Consequently, the communication paths between A and B, B and C, B and D, D and E, D and F, and E and F are not at all burdened by the data transmission.

Shown in FIG. 3 is an enlarged, schematic illustration of the section labeled with III in FIG. 2. The illustrated unit C has three physical, communication interfaces 4. Via communication paths 3, the unit C is directly connected with the neighboring units A, B, E. It is directly networked with all additional units D, F. This embodiment is completely independent of the type of transmission used in each case. It is especially possible, in the network 2 of the invention, to use multiple types of transmission. Considered exemplary for different types of transmission here are the HART-Protocol, the Ethernet standard, the Profibus PA- or Fieldbus Foundation standard. For the purpose of implementation, it is, however, necessary that converters 5 are provided, which support the different types of transfer at the communication interfaces 4. The transmission of data and/or information is supported by the microprocessor 6. A memory unit 7 is assigned to this microprocessor 6.

So that the data and/or information arrive at the designated addressee, some variants of embodiments will now be described as follows, as to how the information preferably is obtained, or conveyed, as the case may be, over the communication paths:

A unit A, B, C, D, E, F knows the topology of the network 2, and understands along which communication path 3, or along which alternative communication path 3, the data and/or information must be transferred in order to arrive at the desired addressee. This information concerning the topology of the network 2 accompanies the traveling data and/or information.

The topology is, for example, stored in the memory unit 7 of a unit A, B, C, D, E, F. On the basis of the address at which the data and/or information should arrive, each unit A, B, C, D, E, F knows along which communication path 3, or along which alternative communication path 3, it must forward the data and/or information.

Through trial/error processes, a unit A, B, C, D, E, F determines the topology of the network 2 by sending the data and/or information to each of the neighboring units. For example, this process is repeated until the data and/or information have reached the desired addressee. The information, acquired in this way, concerning the topology of the network 2 is stored in the memory units 7 of the units A, B, C, D, E, F. Thus, at the same time, the capability (loading, speed) of a communication path 3 can be tested and stored. It can also be provided that the data and/or information is no longer forwarded as soon as a maximum predetermined number of failed attempts is reached, or, as soon as the data and/or information have exceeded a certain age, as the case may be.

Likewise is it possible that the data and/or information are given priorities, with, in each case, the data and/or information with the highest priority being forwarded preferentially along the short and quick communication paths 3.

FIG. 4 shows a block diagram of a second variant of the network 2 of the invention. In particular, it is shown in this figure that, in the network 2 assembled from the individual units A, B, C, D, E, F, various types of transmission can occur. The prerequisite for this is the presence of converters 5 between the different types of transmission. Naturally, the units A, B, C, D, E, F themselves can also assume the function of the converters 5. In the example shown, a first type of transmission, e.g. HART, is represented with circular elements at the ends of the individual communication paths 3, while the square ends on the individual communication paths characterize a second type of transmission, e.g. Profibus PA.

FIG. 5 shows a block diagram of a third variant of the network 2 of the invention. As a result of the multiple networking of the units A, B, C, D, E, F, physical connections between the units A, B, C, D, E, F can be detoured around. This is, for example, of great advantage when, for whatever reason, a provided communication path 3 fails. If, for example, the communication path 3 between A and B fails, then the connections A and C, respectively B and C, still remain as alternative communication paths 3.

Furthermore, the communication paths 3 can, as a result of the multiple networking, be optimally used. If, for example, the load between the units A, B is very high, then the data and/or information can nevertheless quickly reach the desired addressee B via the communication paths 3 between A and C, and C and B. Given that a conventional bus system 1, which becomes loaded as a result of the communication between two units, is no longer present, significantly smaller bandwidths, which are consequently more resistant to interference, can be used for the digital communication. Additionally, small bandwidths prove to be especially advantageous when the units A, B, C, D, E, F are implemented in areas where there is danger of explosion. As mentioned already above, the use of different types of transmission in a network 2 causes no problems.

An optimizing of the communication in the network 2 of the invention can be attained by providing the data and/or information to be transferred with a priority label. In FIG. 5, the case is illustrated in which the data flow between the units A, B is prioritized. Furthermore, it is possible to transfer large amounts of data broken down into individual packets, temporarily in parallel, by way of multiple communication paths 3. With the invention, an increased capacity, compared to the known solutions, can be achieved. As an example for the occurrence of large amounts of data which must be transferred quickly, reference is made to a service call in the case of a fill level measuring device, which determines the fill level on the basis of the echo curve. Echo curves are generated by plotting the amplitude values of the measurement signals as a function of travel time, or travel distance, of the measurement signals.

1-13. (canceled)

14. Adevicefortransmitting, exchanging, and/or forwarding data and/or information, in the context of industrial process- and/or automation technology, between a first unit and at least one second unit of a network of multiple units, each having at least one microprocssor associated therewith, wherein:
said first unit and said at least one second unit is one of: a transmitter or sensor, which provide a measured value for determining a physical or chemical parameter;
said network of multiple units belong to an interconnected group, which communicate with one another either directly or indirectly via at least one intermediate unit; and
each of the units of said network of multiple units has at least two physical, communication interfaces,

15. The device as claimed in claim 14, wherein:
said transmitter or sensor is one of: a fill level measuring device, a pressure transmitter, a flow rate sensor, a temperature sensor, or an analytical device.

16. The device as claimed in claim 14, wherein:
each unit of said network of multiple units is one of: a communication unit, a router, a control/evaluation unit, a parametering unit, or an actuator.

17. The device as claimed in claim 14, wherein:
said at least one microprocessor of said first unit contains information concerning the topology of the network, transmits data and/or information to said at least one second unit; and
preferably the information concerning the topology is transferred with the data and/or information.

18. The device as claimed in claim 17, wherein:
the information concerning the topology is saved in the microprocessors of at least one portion of the units of said network of multiple units, such that the corresponding unit, on the basis of the addressee to which the data and/or information is to be sent, recognizes along which communication path, or along which alternative communication path, it must transmit or forward the data and/or information.

19. The device as claimed in claim 17, wherein:
a unit of said network of multiple units determines the topology of the network of multiple units via communication with a neighboring unit or units, stores the acquired information in a memory unit, and thus recognizes along which communication path or along which alternative communication path it preferably transmits, or forwards, the data and/or information.

20. The device as claimed in claim 19, wherein:
a unit of said network of multiple units determines once, sporadically, or cyclically, the capacities of communication paths to the different units of said network of multiple units communicating with it directly or indirectly, and stores the individual communication paths with their different classifications in an assigned memory unit.

21. The device as claimed in claim 19, wherein:
a unit of said network of multiple units forwards the data and/or information to any one unit of said network of multiple units; and
the respective unit of said network of multiple units receiving the data and/or information forwards the data and/or information in the same manner until the data and/or information reaches the unit of said network of multiple units to which the data and/or information is addressed.

22. The device as claimed in claim 21, wherein:
a unit of said network of multiple units only forwards the data and/or information as long as a predetermined number of forwardings is not yet attained.

23. The device as claimed in claim 14, wherein:
said units of said network of multiple units transfer data and/or information according to predetermined priority criteria.

24. The device as claimed in claim 14, wherein:
a unit of said network of multiple units, in the case of a large amount of data and/or information to be transferred, selects multiple communication paths independent of one another, in order to transfer the data and/or information.

25. The device as claimed in claim 14, wherein:
said units of said network of multiple units are assigned a converter, such that said units can communicate with one another via different types of transmission.

26. The device as claimed in claim 14, wherein:
connection lines, or fiber optic cables, or paths of so-called wireless data and/or information transfer, are provided as communication paths.
